(19) United States
(12) Patent Application Publication
(10) Pub. No.: US 2025/0280350 A1
(43) Pub. Date: Sep. 4, 2025

(54) SYSTEMS AND METHODS FOR DEVICE-TO-DEVICE RELAY COMMUNICATIONS

(71) Applicant: ZTE CORPORATION, Shenzhen (CN)

(72) Inventors: Mengzhen WANG, Shenzhen (CN); Lin CHEN, Shenzhen (CN)

(73) Assignee: ZTE CORPORATION, Shenzhen (CN)

(21) Appl. No.: 19/210,424

(22) Filed: May 16, 2025

Related U.S. Application Data
(63) Continuation of application No. PCT/CN2023/093823, filed on May 12, 2023.

(51) Int. Cl. H04W 40/24; H04W 76/20; H04W 88/04; H04W 92/18

(52) U.S. Cl. CPC H04W 40/246; H04W 76/20; H04W 88/04; H04W 92/18

(57) ABSTRACT

The arrangements described herein relate to systems, methods, apparatuses, and non-transitory computer-readable media for a relay UE providing to a destination UE a source ID of a source wireless communication device for an End-to-End (E2E) unicast link between the source UE and the destination UE. The relay UE provides to the source UE a destination ID of the destination UE for the E2E unicast link.

### CROSS-REFERENCE TO RELATED APPLICATION

This application claims the benefit of priority under 35 U.S.C. § 120 as a continuation of International Patent Application No. PCT/CN2023/093823, filed on May 12, 2023, the disclosure of which is incorporated herein by reference in its entirety.

### TECHNICAL FIELD

The disclosure relates generally to wireless communications and, more particularly, to Device-to-Device (D2D) relay communications and Sidelink (SL) communications.

### BACKGROUND

SL communication refers to wireless radio communication between two or more User Equipments (UEs). In this type of communications, two or more UEs that are geographically proximate to each other can communicate without being routed to a Base Station (BS) or a core network. Data transmissions in SL communications are thus different from typical cellular network communications that include transmitting data to a BS and receiving data from a BS. In SL communications, data is transmitted directly from a source UE to a destination UE (or a target UE) through, for example the Unified Air Interface (e.g., PC5 interface) without passing through a BS.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, a relay UE provides to a destination UE a source ID of a source wireless communication device for an End-to-End (E2E) unicast link between the source UE and the destination UE. The relay UE provides to the source UE a destination ID of the destination UE for the E2E unicast link.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a schematic block diagram illustrating an example wireless communication system supporting SL communications, according to various arrangements.

FIG. 1B is a schematic block diagram illustrating an example wireless communication system supporting SL communications, according to various arrangements.

FIG. 2 illustrates a block diagram of an example Base Station (BS) and an example User Equipment (UE), in accordance with some arrangements.

FIG. 3 is a diagram illustrating protocol stacks for the user plane of Layer 2 (L2) UE-to-UE (U2U) relay architecture, according to various arrangements.

FIG. 4A is a diagram illustrating an example method for establishing End-to-End (E2E) link between a source UE and a destination UE through at least one relay UE, according to various arrangements.

FIG. 4B is a diagram illustrating an example method for establishing E2E link between a source UE and a destination UE through at least one relay UE, according to various arrangements.

FIG. 4C is a diagram illustrating an example method for establishing E2E link between a source UE and a destination UE through at least one relay UE, according to various arrangements.

FIG. 5 is a diagram illustrating an example method for establishing E2E link between a source UE and a destination UE through a relay UE, according to various arrangements.

FIG. 6 is a diagram illustrating an example method for communicating UE IDs for an E2E link between a source UE and a destination UE, according to various arrangements.

FIG. 7 is a diagram illustrating an example method for communicating UE IDs for a first E2E link between a source UE and a destination UE and a second E2E link between the source UE and a destination UE, according to various arrangements.

FIG. 8 is a diagram illustrating an example method for communicating UE IDs for a E2E link between a first UE and a second UE, according to various arrangements.

FIG. 9 is a diagram illustrating an example method for communicating UE IDs for a E2E link between a first UE and a second UE, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, in-door relay communication, smart agriculture, smart factories, public safety, and local advertising have gradually expanded the need for Proximity Services, which allow users to understand and communicate with nearby users or objects. The traditional BS-centric cellular networks have limited high data rate capabilities and support for proximity services. SL is an adaptation of and improvement over the BS-centric communication technology by allowing direct communication between two devices without going through a BS. For example, vehicles, robots, and consumer gadgets can create their own ad hoc networks without directly using the radio access network as an intermediary.

The application of SL technology can meet high data rate requirements for proximity services, reduce the burden of cellular networks, reduce battery power consumption of UEs, and improve the robustness of network infrastructure, thus meeting the above-mentioned requirements of high data rate services and proximity services. SL services can also be referred to as Device-to-Device (D2D) discovery and communication, Proximity Services (ProSe), unilateral communication, sidechain communication, SL discovery and communication, and so on. An example of the interface between two UEs that facilitate SL communications is a PC5 interface.

In some arrangements, to support Layer 2 (L2) UE-to-UE (U2U) relay communication, an adaptation layer is provided over both a first PC5 hops and second PC5 hops. An adaptation header of the adaptation layer includes a bearer Identifier (ID) identifying an end-to-end SL radio bearer between a source UE and a destination UE. In addition, at least an ID that can be mapped to the destination UE is included in the adapt header of the first hop from a source UE to a relay UE for identifying the destination of the packet to the relay UE, and an ID that can be mapped to the source UE is included in the adaptation header of the second hop between the relay UE to the destination UE to identify the source of the packet for the destination UE. The arrangements disclosed herein the ID is mappable to the source/destination UE, and it is not clear how does the involved UEs (source/destination/relay UE) negotiate/assign/acquire the ID mappable to the source/destination UE and how to support U2U relay communication in multi-hop scenario.

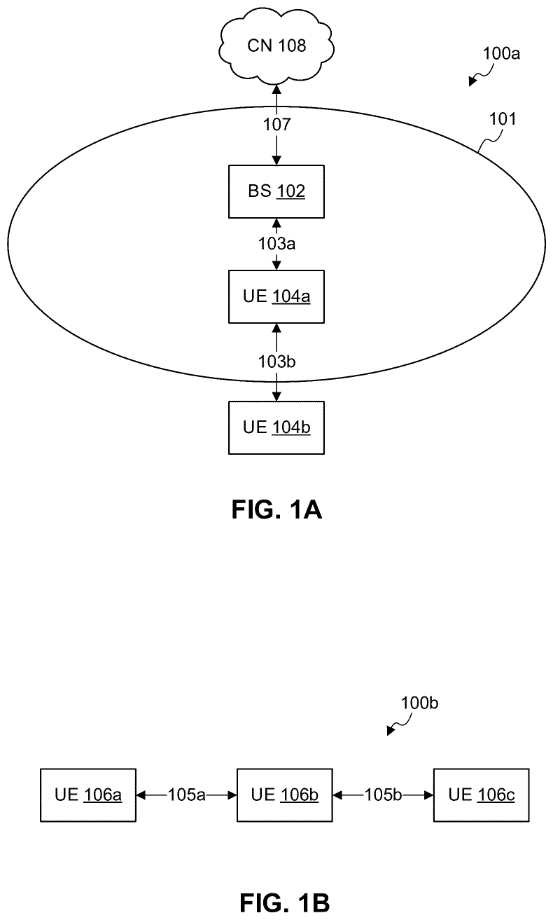

FIG. 1A is a schematic block diagram illustrating an example wireless communication system 100a supporting SL communications, according to various arrangements. In the system 100a, a BS 102 (e.g., a network-side communication node, a wireless communication node, and so on) can include a next Generation Node B (gNB), an E-UTRAN Node B (also known as Evolved Node B, eNodeB or eNB), a pico station, a femto station, a Transmission/Reception Point (TRP), an Access Point (AP), or so on. Each of the UEs 104a and 104b (e.g., a terminal-side node, a wireless communication device, and so on) can include a device such as mobile device, a smart phone, a cellular phone, a Personal Digital Assistant (PDA), a tablet, a laptop computer, a wearable device, a vehicle with a vehicular communication system, or so on. FIG. 1A illustrates a UE-to-Network (U2N) deployment scenario.

In FIG. 1A, the BS 102 can provide wireless communication services to UEs within a cell 101, in which at least the UE 104a is located. The UE 104a can be moving or remaining stationary within a coverage of the cell 101. The UE 104a can communicate with the BS 102 via a communication channel 103a. The UEs 104a and 104b can communicate with each other via a communication channel 103b. The communication channel 103a between the UE 104a and the BS 102 can be implemented using an interface such as an Uu interface, which is also known as Universal Mobile Telecommunication System (UMTS) air interface. The communication channel 103b between the UEs 104a and 104b is a SL communication channel and can be implemented using an interface such as a PC5 interface. The SL communication interface is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, and the like. In some instances, vehicle network communications modes can be collective referred to as Vehicle-to-Everything (V2X) communications. The BS 102 is connected to a Core Network (CN) 108 through an external interface 107, such as an Iu interface.

To improve the support of applications and services (e.g., in indoor relay communications, smart agriculture, smart factories, public security, and so on), SL-based relay communications can be used to extend the coverage and improve the power consumption. In FIG. 1A, the remote UE (e.g., the UE 104b) can be in an area with weak or no coverage from the BS 102 and the cell 101. Thus, the UE 104b does not directly communicate with the BS 102 or the CN 108 and communicates indirectly with the BS 102 and the CN 108 using the SL communication channel 103b and via a relay UE (e.g., the UE 104a). The UE 104a can directly communicate with the BS 102 and the CN 108 or indirectly communicate with the BS 102 and the CN 108 via at least one other relay UE that can directly communicate with the BS 102 and the CN 108. As a result, the coverage of the network is extended and the capacity of the network is increased. The UE 104a is referred to as a U2N relay and the UE 104b is referred to as the remote UE. In the example in which the UE 104b is within the coverage of the BS 102 and the cell 101, the UE 104b can switch to a direct path, similar to the communication channel 103a. In addition, a multi-path relay can be supported. For example, the in-coverage remote UE 104b is connected to CN 108 via both a direct path and an indirect path, thus improving the reliability/robustness as well as throughput. The direct path refers to a path by which data is transmitted directly between the UE 104b and BS 102 via a direct communication channel. The direct path refers to a path that includes both a direct path (e.g., the communication channel 103a) and at least one SL path (e.g., the communication channel 103b), such that data from the UE 104b is forwarded to the BS 102 via the relay UE 104a.

FIG. 1B is a schematic block diagram illustrating an example wireless communication system 100b supporting SL communications, according to various arrangements. In the system 100b, each of the UEs 106a, 106b, and 106c (e.g., a terminal-side node, a wireless communication device, and so on) can include a device such as mobile device, a smart phone, a cellular phone, a PDA, a tablet, a laptop computer, a wearable device, a vehicle with a vehicular communication system, or so on. FIG. 1B illustrates a U2U deployment scenario.

In some scenarios such as one that involves a catastrophe or emergency, a cellular network (including the CN 108 and the BS 102) may not function properly. In order to expand the coverage range of the SL communications, a multi-hop relay using one or more UE devices can be implemented. As shown in FIG. 1B, the UE 106a communicates with the UE 106c via the UE 106b. The UE 106b can be referred to as a U2U relay device or relay UE. The UEs 106a and 106c can be referred to as remote UEs. The communication channel 105a between the UEs 106a and 106b is a SL communication channel and can be implemented using an interface such as a PC5 interface. The communication channel 105b between the UEs 106b and 106c is a SL communication channel and can be implemented using an interface such as a PC5 interface.

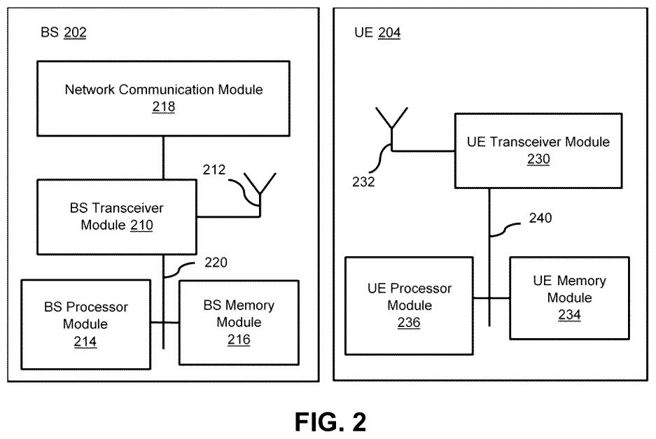

FIG. 2 illustrates a block diagram of an example BS 202 and an example UE 204, in accordance with some arrangements. The BS 202 is an example of the BS 102. The UE 204 is an example of the UEs 104a, 104b, 106a, 106b, and 106c, and any source UEs, destination UEs, and relay UEs described herein.

The BS 202 includes a BS transceiver module 210, a BS antenna 212, a BS processor module 214, a BS memory module 216, and a network communication module 218, each module being coupled and interconnected with one another as needed via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel, which can be any wireless channel or other medium suitable for transmission of data as described herein.

The BS 202 and the UE 204 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as a UL transceiver 230 that includes a Radio Frequency (RF) transmitter and a RF receiver each including circuitry that is coupled to the antenna 232. A duplex switch (not shown) may alternatively couple the UL transmitter or receiver to the UL antenna in time duplex fashion. Similarly, in accordance with some implementations, the BS transceiver 210 may be referred to herein as a Downlink (DL) transceiver 210 that includes a RF transmitter and a RF receiver each including circuity that is coupled to the antenna 212. A DL duplex switch may alternatively couple the DL transmitter or receiver to the DL antenna 212 in time duplex fashion. The operations of the two transceiver modules 210 and 230 can be coordinated in time such that the UL receiver circuitry is coupled to the UL antenna 232 for reception of transmissions over the wireless transmission link at the same time that the DL transmitter is coupled to the DL antenna 212. In some implementations, there is close time synchronization with a minimal guard time between changes in duplex direction.

The UE transceiver 230 and the BS transceiver 210 are configured to communicate via a wireless data communication link, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof. The UE transceivers 230 of different UEs 204 are configured to communicate via a SL wireless data communication link, as described herein.

In accordance with various implementations, the BS 202 may be an eNB, gNB, a serving eNB, a target eNB, a femto station, a TRP, a pico station, or another UE, for example. In some implementations, the UE 204 can be various types of user devices such as a mobile phone, a smart phone, a PDA, tablet, laptop computer, wearable computing device, a terminal, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 represents the hardware, software, firmware, processing logic, and/or other components of the BS 202 that enable bi-directional communication between BS transceiver 210 and other network components and communication nodes configured to communication with the BS 202, such as those associated with the CN 108. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

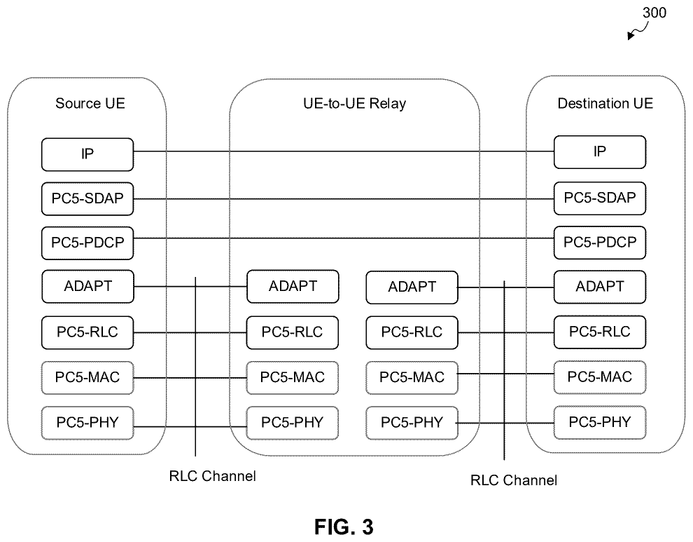

The protocol stacks of L2 U2U relay architecture are similar to L2 U2N relay other than the termination points are two remote UEs. FIG. 3 is a diagram illustrating protocol stacks 300 for the user plane of L2 U2U relay architecture, according to various arrangements. As shown, the source UE (e.g., the UE 106a) has various protocol stacks including an Internet Protocol (IP) layer, a PC5-Service Data Adaptation Protocol (SDAP) layer, a PC5-Packet Data Convergence Protocol (PDCP) layer, an adaptation (ADAPT) layer, a PC5-Radio Link Control (RLC) layer, a PC5-Media Access Control (MAC), and a PC5-Physical (PHY) layer. The U2U relay (e.g., the UE 106b) includes an ADAPT layer coupled to the ADAPT layer of the source UE via a first RLC channel (e.g., a first PC5 link), a PC5-RLC layer coupled to the PC5-RLC layer of the source UE via the first RLC channel, a PC5-MAC layer coupled to the PC5-MAC layer of the source UE via the first RLC channel, a PC5-PHY layer coupled to the PC5-PHY layer of the source UE via the first RLC channel, an ADAPT layer coupled to the ADAPT layer of the destination UE via a second RLC channel (e.g., a second PC5 link), a PC5-RLC layer coupled to the PC5-RLC layer of the destination UE via the second RLC channel, a PC5-MAC layer coupled to the PC5-MAC layer of the destination UE via the second RLC channel, and a PC5-PHY layer coupled to the PC5-PHY layer of the destination UE via the second RLC channel. The destination UE (e.g., the UE 106c) includes an ADAPT layer, a PC5-RLC layer coup, a PC5-MAC layer, and a PC5-PHY layer.

The ADAPT layer is supported over the first and second PC5 links for L2 U2U relay. The first PC5 link refers to the PC5 link between the source UE and the relay UE. The second PC5 link refers to the PC5 link between the relay UE and the destination UE. For L2 U2U relay, the ADAPT layer is configured over an RLC sublayer for both Control Plane (CP) and User Plain (UP) over the second PC5 link. The SL SDAP/PDCP and Radio Resource Control (RRC) are terminated between two remote UEs, while RLC, MAC and PHY are terminated in each PC5 link.

The adaptation header can include a bearer ID identifying an End-to-End (E2E) SL radio bearer between the source UE (e.g., the UE 106a) and the destination UE (e.g., the UE 106c). In addition, at least an ID mappable to the destination UE is included in the adapt header of the first hop (e.g., the first PC5 link or the first RLC channel) for the relay UE (e.g., the UE 106b) to identify the destination of the packet. An ID mappable to the source UE is included in the adapt header of the second hop (e.g., the second PC5 link or the second RLC channel) for the destination UE to identify the source of the packet.

For L2 U2U relay communications, E2E PC5 unicast link between the source UE and the destination UE can be established after per hop PC5 unicast link has been established between the source UE and the relay UE and between the relay UE and the destination UE. Conventionally, after establishing per hop PC5 unicast link, each of the source UE, relay UE, and the destination UE are provided with the user information ID of the other two UEs. The source UE obtains the L2 ID of the relay UE for the PC5 unicast link communication of the first hop. The destination UE obtains the L2 ID of the relay UE for the PC5 unicast link communication of the second hop. The relay UE obtains the L2 IDs of the source UE and the destination UE for the two-hop PC5 unicast link communication. Conventionally, the source UE, relay UE, and the destination UE are not provided the L2 IDs of the source UE and the destination UE used for E2E PC5 unicast link.

Conventionally, a UE obtains a peer UE's L2 ID in the PC5 unicast link establishment procedure. For L2 U2U relay communications, the source UE and the destination UE are provided with the L2 IDs of one another used for E2E PC5 unicast link before establishing E2E PC5 unicast link, in the examples in which L2 ID is used as the ID mappable to source UE and the destination UE in the adaptation header. In addition, the relay UE is provided with the L2 IDs of the source UE and the destination UE for E2E PC5 unicast link for bearer mapping. Some arrangements relate to providing the source UE, the destination UE, and the relay UE with the L2 IDs of the destination UE and the source UE for E2E PC5 unicast link.

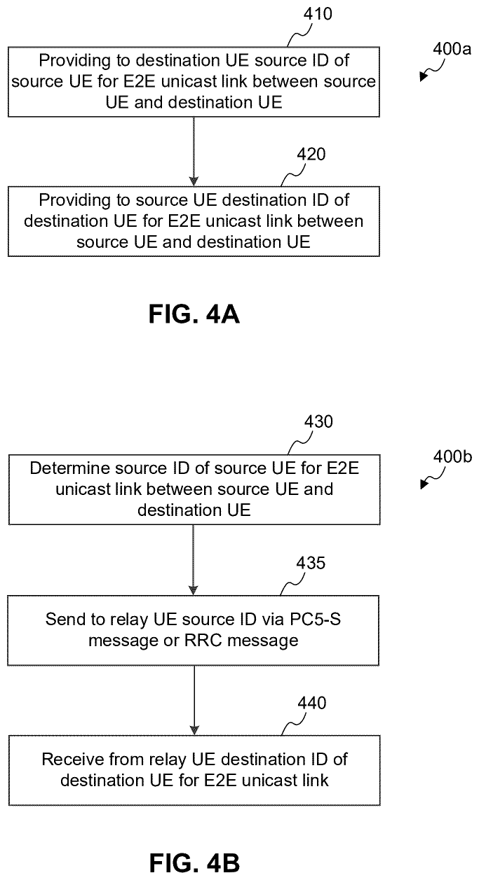

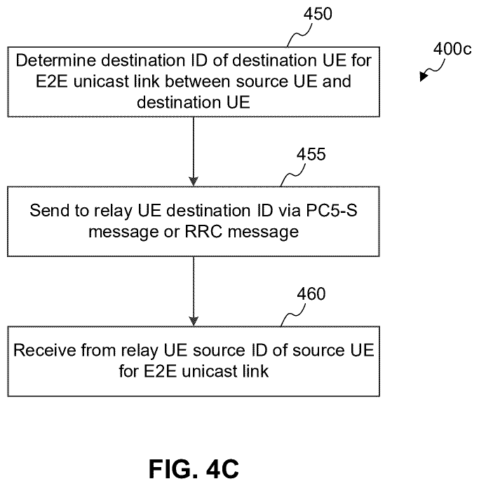

FIG. 4A is a diagram illustrating an example method 400a for establishing E2E link between a source UE and a destination UE through at least one relay UE, according to various arrangements. The method 400a can be performed using the system 100b. For example, the method 400a can be performed by a relay UE (e.g., the UE 106b). The relay UE can communicate with a source UE (e.g., the UE 106a) and a destination UE (e.g., the UE 106c). In some examples, the relay UE can communicate with an upstream relay UE, which is between the source UE and the relay UE along the communication path. In such examples, the relay UE communicates indirectly with the source UE via the upstream relay UE. In some examples, the relay UE can communicate with a downstream relay UE, which is between the destination UE and the relay UE along the communication path. In such examples, the relay UE communicates indirectly with the destination UE via the downstream relay UE. Examples of the upstream and downstream UEs can be the UE 204.

At 410, the relay UE provides to the destination UE a source ID (e.g., an L2 ID) of the source UE for an E2E unicast link between the source UE and the destination UE. At 420, the relay UE provides to the source UE a destination ID of the destination UE for the E2E unicast link between the source UE and the destination UE.

FIG. 4B is a diagram illustrating an example method 400b for establishing E2E link between a source UE and a destination UE through at least one relay UE, according to various arrangements. The method 400b can be performed using the system 100b. For example, the method 400b can be performed by a source UE (e.g., the UE 106a). The source UE can communicate with a relay UE (e.g., the UE 106b) and a destination UE (e.g., the UE 106c).

At 430, the source UE determines a source ID (e.g., an L2 ID or a local ID) of the source UE for an E2E unicast link between the source UE and the destination UE. At 435, the source UE sends to the relay UE the source ID via a PC5-S message or the RRC message. At 440, the source UE receives from a relay UE via a PC5-S message or the RRC message a destination ID (e.g., an L2 ID or a local ID) of the destination UE for the E2E unicast link.

FIG. 4C is a diagram illustrating an example method 400c for establishing E2E link between a source UE and a destination UE through at least one relay UE, according to various arrangements. The method 400c can be performed using the system 100b. For example, the method 400c can be performed by a destination UE (e.g., the UE 106c). The destination UE can communicate with a relay UE (e.g., the UE 106b) and a source UE (e.g., the UE 106a).

At 450, the destination UE determines a destination ID (e.g., an L2 ID or a local ID) of the destination UE for an E2E unicast link between the source UE and the destination UE. At 455, the destination UE sends to the relay UE the destination ID via a PC5-S message or the RRC message. At 460, the destination UE receives from a relay UE via a PC5-S message or the RRC message a source ID (e.g., an L2 ID or a local ID) of the source UE for the E2E unicast link.

Features described herein relative to one of methods 400a, 400b, and 400c can be likewise implemented for other ones of the methods 400a, 400b, and 400c.

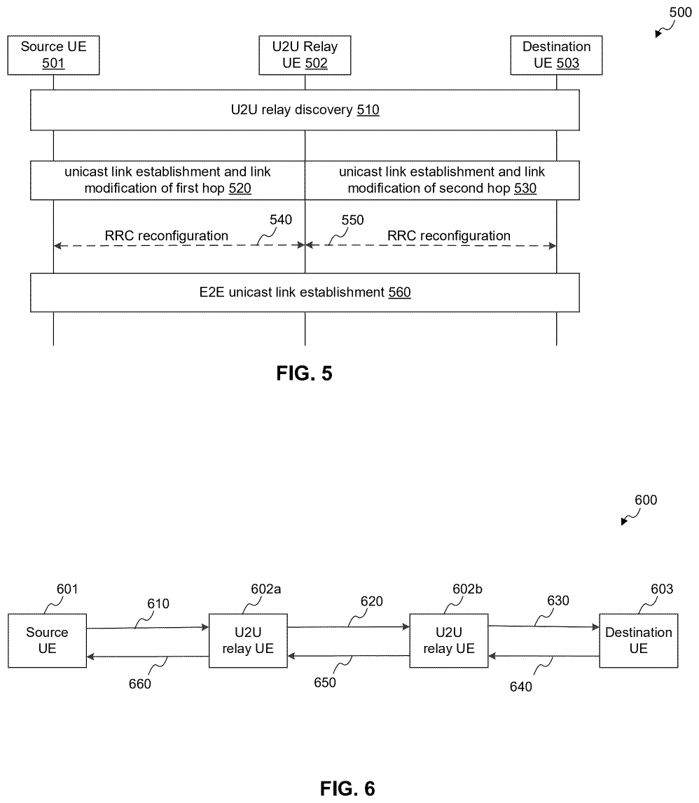

FIG. 5 is a diagram illustrating an example method 500 for establishing E2E link between a source UE 501 and a destination UE 503 through a relay UE 502, according to various arrangements. The method 500 can be performed using the system 100b. For example, the source UE 501 is an example of the UE 106a. The U2U relay UE 502 is an example of the UE 106b. The destination UE 503 is an example of the of the UE 106c. Each of the UEs 501, 502, and 503 can be a UE such as the UE 204. At 510, the source UE 501, the relay UE 502, and the destination UE 503 perform a U2U relay discovery procedure to find the relay UE that can reach the source UE and the destination UE.

At 520, to serve the source UE and destination UE, e.g. forward signaling and user data between the source UE and destination UE, the source UE 501 and the relay UE 502 perform a unicast link establishment or a link modification of a first hop. The unicast link can be a PC5 unicast link. The first hop, also referred to as a first PC5 link, first SL channel/link, or the first RLC channel, refers to a communication link or channel between the source UE 501 and the relay UE 502. An example of the first hop is the communication channel 105a between the UEs 106a and 106b.

At 530 to serve the source UE and destination UE, e.g. forward signaling and user data between the source UE and destination UE, the relay UE 502 and the destination UE 503 perform a unicast link establishment or a link modification of a second hop. The unicast link can be a PC5 unicast link. The second hop, also referred to as a second PC5 link, second SL channel/link, or the second RLC channel, refers to a communication link or channel between the relay UE 502 and the destination UE 503. An example of the second hop is the communication channel 105b between the UEs 106b and 106c.

At 540 to negotiate PC5 RLC channels used to transmit E2E SL-Signaling Radio Bearers (SRBs), the source UE 501 and the relay UE 502 perform RRC reconfiguration (e.g., PC5 RRC reconfiguration). At 550 to negotiate PC5 RLC channels used to transmit E2E SL-SRBs, the relay UE 502 and the destination UE 503 perform RRC reconfiguration (e.g., PC5 RRC reconfiguration). At 560, the source UE 501, the relay UE 502, and the destination UE 503 perform E2E unicast link establishment establish an E2E unicast link (e.g., an E2E PC5 unicast link) between the source UE and the destination UE.

In some arrangements, the IDs (e.g., L2 IDs) of the UEs 501, 502, and 503 are exchanged in the per hop (or single-hop) unicast link establishment procedure using PC5-S messages in 520 and 530. For example, the source UE 501 assigns its ID, referred to as the source ID, used for the E2E unicast link (e.g., established at 560). The source UE 501 includes the source ID in a first per hop Direct Communication Request (DCR) message and sends the first per hop DCR message to the relay UE 502 in 520.

In some arrangements, the source ID used to identify the source UE 501 for the E2E unicast link can be the same as the per hop UE ID used to identify the source UE 501 for the per hop link (e.g., the first hop established in 520). In such arrangements, an indication indicating that the source ID used for E2E unicast link is the same as the per hop UE ID used for per hop link (e.g., the first hop) is provided in the PC5-S messages, and the per hop UE ID is provided in the MAC header. In some arrangements, the source ID used for the E2E link (established at 560) can be different from the per hop UE ID used for the first hop, in which case, the source UE 501 provides to the relay UE 502 the per hop UE ID in the MAC header and the source ID to the relay UE 502 in a PC5-S message (e.g., the first per hop DCR message).

The relay UE 502 includes the source ID in a second per hop DCR message and sends the second per hop DCR message to the destination UE 503 in 530. The second per hop DCR message includes the source ID that the relay UE 502 received from source UE 501 in the first hop DCR message, which can be the same as the per hop UE ID or different from the per hop UE ID.

In response to receiving the second per hop DCR message from the relay UE 502 including the source ID of the source UE 501, the destination UE 503 assigns its ID, referred to as the destination ID, used for the E2E unicast link (e.g., established at 560). The destination UE 503 includes the destination ID in a first per hop Direct Communication Accept/Acknowledgement (DCA) message and sends the first per hop DCA message to the relay UE 502 in 530. A DCA originating from the destination UE 503 is responsive to a DCR originating from the source device 501. Examples of the PC5-S message includes DCRs and DCAs.

In some arrangements, the destination ID used to identify the destination UE 503 for the E2E unicast link can be the same as the per hop UE ID used to identify the destination UE 503 for the per hop link (e.g., the second hop established in 530). In such arrangements, an indication indicating that the destination ID used for E2E unicast link is the same as the per hop UE ID used for per hop link (e.g., the second hop) is provided in the PC5-S messages, and the per hop UE ID is provided in the MAC header. In some arrangements, the destination ID used for the E2E link (established at 560) can be different from the per hop UE ID used for the second hop, in which case, the destination UE 503 provides the per hop UE ID in the MAC header and the destination ID to the relay UE 502 in a PC5-S message (e.g., the first per hop DCA message) to the relay UE 502.

The relay UE 502 includes the destination ID in a per hop DCA message of the first hop and sends the per hop DCA message of the first hop to the source UE 501 in 520. The per hop DCA message includes the destination ID that the relay UE 502 received from destination UE 503 in the per hop DCA message of the second hop, which can be the same as the per hop UE ID or different from the per hop UE ID.

As used herein, a source ID is an ID that identifies the source UE (also referred to as a first UE), which may be the source of messages, data packets, signals, commands, and so on, but also can be the destination of messages, data packets, signals, commands, and so on originating from another device such as the destination device. A destination ID is an ID identifying the destination UE (also referred to as a second UE), which may be the destination of messages, data packets, signals, commands, and so on, but also can be the source of messages, data packets, signals, commands, and so on intended for another device such as the source device.

In some arrangements, in the method 400a, the source ID is provided using a first PC5-S message received by the relay UE from the source UE and a second PC5-S message sent by the relay UE to the destination UE.

In some arrangements, in the method 400a, providing the source ID to the destination UE at 410 includes receiving, by the relay UE from the source UE via a first link (e.g., a first hop) between the source UE and the relay UE, a first PC5-S message (e.g., a first DCR). The first PC5-S message includes one of the source ID (the source ID is different from the ID, e.g., the per hop UE ID) used to identify the source device for the first link) or an indication indicating that the source ID for the E2E unicast link is same as an ID used to identify the source device for the first link. The ID used to identify the source UE for the first link is included in the MAC header of the first link. The method 400a further includes sending, by the relay UE to the destination UE via a second link (a second hop) between the relay UE and the destination UE, a second PC5-S message (e.g., a second DCR) including the source ID.

In some arrangements, in the method 400a, providing the destination ID to the source UE at 420 includes receiving, by the relay UE from the destination UE via a second link (a second hop) between the destination UE and the relay UE, a third PC5-S message (e.g., a first DCA). The third PC5-S message includes one of the destination ID (the destination ID is different from an ID, e.g., the per hop UE ID, used to identify the destination device for the second link) or an indication indicating that the destination ID for the E2E unicast link is same as the ID used to identify the destination UE for the second link. The ID used to identify the destination UE for the first link is included in the MAC header of the first link. The method 400a further includes sending by the relay UE to the source UE via the first link (a first hop) between the relay UE and the source UE, a fourth PC5-S message (e.g., a second DCA) including the destination ID.

In some arrangements, the IDs (e.g., L2 IDs) of the UEs 501, 502, and 503 are exchanged in the per hop (or single-hop) PC5 RRC reconfiguration procedure via PC5-RRC messages in 540 and 550. For example, the source UE 501 assigns its source ID used for the E2E unicast link (e.g., established at 560). The source UE 501 includes the source ID in a first RRC message (e.g., an RRC reconfiguration SL message or RRCReconfigurationSidelink message) and sends the first RRC message to the relay UE 502 in 540.

In some arrangements, the source ID used to identify the source UE 501 for the E2E unicast link can be the same as the per hop UE ID used to identify the source UE 501 for the per hop link (e.g., the first hop established in 520 and for the RRC reconfiguration 540). In such arrangements, an indication indicating that the source ID used for E2E unicast link is the same as the per hop UE ID used for per hop link (e.g., the first hop) is provided in the PC5-RRC messages instead of an ID of the source UE 501 for the E2E unicast link. In some arrangements, the source ID used for the E2E link (established at 560) can be different from the per hop UE ID used for the first hop, in which case, the source UE 501 provides both the per hop UE ID in the MAC header and the source ID to the relay UE 502 in a PC5-RRC message (e.g., the first RRC message) to the relay UE 502.

The relay UE 502 includes the source ID in a second RRC message (e.g., an RRC reconfiguration SL message or RRCReconfigurationSidelink message) and sends the second RRC message to the destination UE 503 in 550. The second RRC message includes the source ID that the relay UE 502 received from source UE 501 in the first RRC message, which can be the same as the per hop UE ID or different from the per hop UE ID. In some examples, the relay UE 502 includes a user information ID of the source UE 501 in the second RRC message to identify the source UE 501 in addition to the source ID.

In response to receiving the second RRC message from the relay UE 502 including the source ID of the source UE 501, the destination UE 503 assigns its ID, referred to as the destination ID, used for the E2E unicast link (e.g., established at 560). The destination UE 503 includes the destination ID in a third RRC message (e.g., an RRC reconfiguration SL message or RRCReconfigurationSidelink message) and sends the third RRC message to the relay UE 502 in 550.

In some arrangements, the destination ID used to identify the destination UE 503 for the E2E unicast link can be the same as the per hop UE ID used to identify the destination UE 503 for the per hop link (e.g., the second hop established in 530 and for the RRC reconfiguration 550). In such arrangements, an indication indicating that the destination ID used for E2E unicast link is the same as the per hop UE ID used for per hop link (e.g., the second hop) is provided in the PC5-RRC messages instead of an ID of the destination UE 501 for the E2E unicast link. In some arrangements, the destination ID used for the E2E link (established at 560) can be different from the per hop UE ID used for the second hop, in which case, the destination UE 503 provides both the per hop UE ID in the MAC header and the destination ID to the relay UE 502 in a PC5-RRC message (e.g., the third RRC message) to the relay UE 502.

The relay UE 502 includes the destination ID in a fourth RRC message and sends the fourth RRC message to the source UE 501 in 540. The fourth RRC message includes the destination ID that the relay UE 502 received from destination UE 503 in the third RRC message, which can be the same as the per hop UE ID or different from the per hop UE ID. In some examples, the relay UE 502 includes a user information ID of the destination UE 503 in the fourth RRC message to identify the destination UE 501 in addition to the source ID.

In some arrangements, in the method 400a, the source ID is provided using a first RRC reconfiguration message (e.g., a first RRC reconfiguration SL message) received by the relay UE from the source UE and a second RRC reconfiguration message (e.g., a second RRC reconfiguration SL message) sent by the relay UE to the destination UE.

In some arrangements, in the method 400a, providing the source ID to the destination UE at 410 includes receiving, by the relay UE from the source UE via a first link (first hop) between the source UE and the relay UE, a first RRC message, the first RRC message includes one of the source ID (the source ID is different from an ID, e.g., a per hop UE ID, used to identify the source UE for the first link) or an indication indicating that the source ID for the E2E unicast link is same as the ID used to identify the source device for the first link. The ID used to identify the source UE for the first link is included in the MAC header of the first link. The method 400a further includes sending, by the relay UE to the destination UE via a second link (a second hop) between the relay UE and the destination UE, a second RRC message including the source ID.

In some arrangements, the second RRC message further includes a user information ID of the source UE different from the source ID and the ID used to identify the source UE for the first link. The user information ID corresponds or maps to the source ID. The user information ID indicates the source UE to which the source ID belongs. In the example in which both a first source UE and a second source UE are establishing the E2E link with the destination UE, the different user information IDs of the first and second source UEs can be used by the destination UE to identify the source IDs as belonging respective user information IDs.

some arrangements, in the method 400a, providing the destination ID to the source UE at 420 includes receiving, by the relay UE from the destination UE via a second link (a second hop) between the destination UE and the relay UE, a third RRC message. The third RRC message includes one of the destination ID (the destination ID is different from an ID, e.g., the per hop UE ID, used to identify the destination device for the second link) or an indication indicating that the destination ID for the E2E unicast link is same as the ID used to identify the destination UE for the second link. The ID used to identify the destination UE for the first link is included in the MAC header of the first link. The method 400a further includes sending by the relay UE to the source UE via the first link (a first hop) between the relay UE and the source UE, a fourth RRC message including the destination ID.

In some arrangements, the fourth RRC message further includes a user information ID of the destination UE different from the destination ID and the ID used to identify the destination UE for the first link. The user information ID corresponds or maps to the destination ID. The user information ID indicates the destination UE to which the destination ID belongs. In the example in which both a first destination UE and a second destination UE are establishing the E2E link with the source UE, the different user information IDs of the first and second destination UEs can be used by the source UE to identify the source IDs as belonging respective user information IDs.

Accordingly, the source UE 501 can include its L2 ID (used for the E2E PC5 link) or an indication (indicating the L2 ID used for E2E PC5 link is the same as L2 ID used for per hop PC5 link) in the per hop PC5-S or PC5-RRC messages that are sent to the relay UE 502 in the first hop. The relay UE 502 includes the L2 ID of the source UE 501 in the per hop PC5-S or PC5-RRC messages that are sent to the destination UE 503 in the second hop.

In the examples in which PC5-RRC messages are used, the user info ID of the source UE 501 is also included to identify the source UE 501. The destination UE 503 likewise includes its L2 ID or an indication in the per hop PC5-S or PC5-RRC messages that are sent to the relay UE 501. The relay UE 502 includes the L2 ID of the destination UE 503 in the per hop PC5-S or PC5-RRC messages (which includes the user info ID of the destination UE) that are sent to source UE.

FIG. 6 is a diagram illustrating an example method 600 for communicating UE IDs for an E2E link between a source UE 601 and a destination UE 603, according to various arrangements. Each of the UEs 601, 602a, 602b, and 603 can be a UE such as the UE 204. FIG. 6 is directed to a multi-hop scenario in which there are two or more U2U relay UEs 602a and 602b between the source UE 601 and the destination UE 603.

At 610, the source UE 601 sends to the relay UE 602a the source ID (e.g., the L2 ID) identifying the source UE 601 for an E2E link or an indication that the source ID is the same as the per hop UE ID used for the first hop between the source UE 601 and the relay UE 602a, in a PC5-S message or PC5-RRC message. At 620, the relay UE 602a sends the source ID to the relay UE 602b via a second hop, in a PC5-S message or PC5-RRC message. At 630, the relay UE 602b sends the source ID to the destination UE 603 via a third hop, in a PC5-S message or PC5-RRC message.

At 640, the destination UE 603 sends to the relay UE 602b the destination ID (e.g., the L2 ID) identifying the destination UE 603 for the E2E link or an indication that the destination ID is the same as the per hop UE ID used for the third hop between the destination UE 603 and the relay UE 602b, in a PC5-S message or PC5-RRC message. At 650, the relay UE 602b sends the destination ID to the relay UE 602a via the second hop, in a PC5-S message or PC5-RRC message. At 660, the relay UE 602a sends the destination ID to the source UE 601 via the first hop, in a PC5-S message or PC5-RRC message.

In the examples in which the PC5-RRC messages are used, the user info ID of the source UE 601 and of the destination UE 603 are also included in the PC5-RRC messages to identify the source UE 601 and of the destination UE 603 respectively.

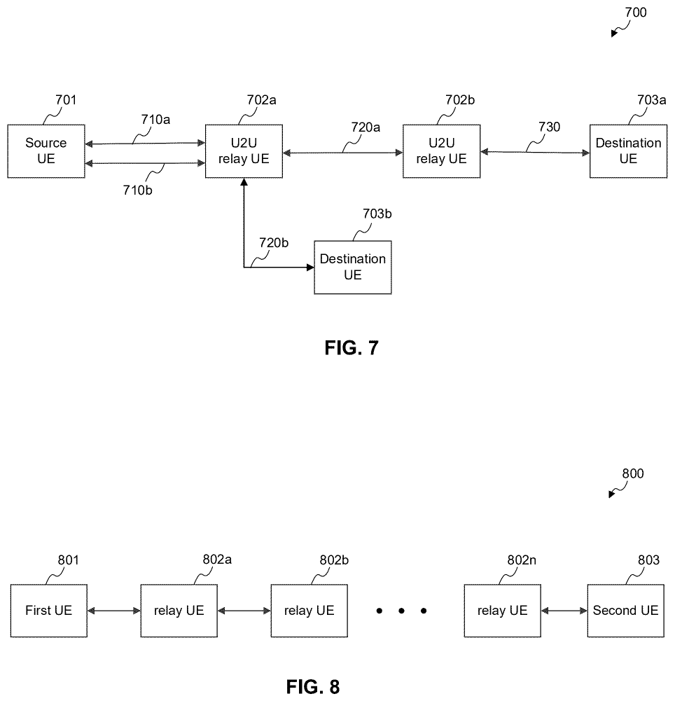

FIG. 7 is a diagram illustrating an example method 700 for communicating UE IDs for a first E2E link between a source UE 701 and a destination UE 703a and a second E2E link between the source UE 701 and a destination UE 703b, according to various arrangements. Each of the UEs 701, 702a, 702b, 703a, and 703b can be a UE such as the UE 204. FIG. 7 is directed to a multi-hop scenario in which there is at least one U2U relay UE 702a and 702b between the source UE 701 and the destination UEs 703a and 703b via two communication paths.

For example, the source UE 701 can communicate with the destination UE 703a via a first communication path including hop 710b between the source UE 701 and the relay UE 702a, hop 720a between the relay UE 702a and relay UE 702b, hop 730 between the relay UE 702b and the destination UE 703a in order to establish the first E2E link.

The source UE 701 can communicate with the destination UE 703b via a second communication path including the hop 710b between the source UE 701 and the relay UE 702a, hop 720b between the relay UE 702a the destination UE 703b in order to establish the second E2E link. To exchange UE IDs via the second communication path, the source UE 701 sends to the relay UE 702a the source ID (e.g., the L2 ID) identifying the source UE 701 for the second E2E link or an indication that the source ID is the same as the per hop UE ID used for the hop 710b between the source UE 701 and the relay UE 702a, in a PC5-S message or PC5-RRC message. The relay UE 702a sends the source ID to the destination UE 703b via a hop 720b, in a PC5-S message or PC5-RRC message. The destination UE 703b sends to the relay UE 702a the destination ID (e.g., the L2 ID) identifying the destination UE 703b for the second E2E link or an indication that the destination ID is the same as the per hop UE ID used for the hop 720b between the destination UE 703b and the relay UE 702a, in a PC5-S message or PC5-RRC message. The relay UE 702a sends the destination ID to the source UE 701 via the hop 710b, in a PC5-S message or PC5-RRC message.

Given that the L2 ID (e.g., a source ID or a destination ID) is assigned by the UE (e.g., the source UE 701 and the destination UEs 703a and 703b) identified by the L2 ID, different UEs may assign the same L2 ID. In the example in which the second communication path is established first, and the UE 703b assigns a destination ID (e.g., IDx) for itself to use for the second E2E link between the source UE 701 and the destination UE 703b. In establishing the first communication path subsequent, the destination UE 703a may assign the same L2 ID (e.g., IDx) for itself to use for the first E2E link between the source UE 701 and the destination UE 703a. If IDx is used to identify both the destination UEs 703a and 703b, when the source UE 701 sends a data packet to the UE identified by IDx, the source UE 701 includes IDx in the adapt header, the relay UE 702a would fail to determine whether to send the data packet to the destination UE 703a or the destination UE 703b.

To exchange UE IDs via the first communication path which is after the UE IDs are exchanged via the first communication path, the source UE 701 sends to the relay UE 702a the source ID (e.g., the L2 ID) identifying the source UE 701 for the first E2E link or an indication that the source ID is the same as the per hop UE ID used for the hop 710a between the source UE 701 and the relay UE 702a, in a PC5-S message or PC5-RRC message. The relay UE 702a sends the source ID to the relay UE 702b via a hop 720a, in a PC5-S message or PC5-RRC message. The relay UE 702a sends the source ID to the destination UE 703a via a hop 730, in a PC5-S message or PC5-RRC message.

The destination UE 703a sends to the relay UE 702b the destination ID (e.g., the L2 ID) identifying the destination UE 703a for the first E2E link or an indication that the destination ID is the same as the per hop UE ID used for the hop 730 between the destination UE 703a and the relay UE 702b, in a PC5-S message or PC5-RRC message. The relay UE 702a sends the destination ID to the relay UE 702a via the hop 720a, in a PC5-S message or PC5-RRC message. The relay UE 702 can detect ID collision given that the new destination ID is the same as the destination ID that is already in use to identify another destination UE 703b for a previously established communication link or E2E unicast link.

In some examples, to avoid such L2 ID collision, the relay UE 702a assigns a new destination ID for the destination UE 703a and provides the new destination ID for the destination UE 703a to the source UE 701 (via the hop 710a and using a PC5-S message or PC5-RRC message) and to any upstream or downstream relay UEs such as the relay UE 702b (via the hop 720a and using a PC5-S message or PC5-RRC message). The relay UE 702a maintains a mapping (e.g., a mapping table) of the original destination ID (one that is assigned by the destination UE 703a itself) and the new destination ID in a memory (e.g., the UE memory module 234).

In some arrangements, the method 400a further includes in response to determining that an original destination ID of the destination UE is currently used by another destination UE for another E2E unicast link, the relay UE assigns the destination ID (a new destination ID) for the destination UE, stores in a memory (e.g., the UE memory module 234) a mapping of the original destination ID for the destination UE to the destination ID for the destination UE, and sends to the source UE the destination ID.

In response to the relay UE 702a receiving a data packet from the source UE 701 with the new destination ID for the destination UE 703a in the adapt header, the relay UE 702a looks up the original destination ID using the new destination ID in the mapping table and replaces the new destination ID with the original destination ID of the destination UE 703a in the adapt header. The relay UE 702a sends the data packet with the original destination ID of the destination UE 703a in the adapt header to the relay UE 702b, which forwards the data packet to the destination UE 703a.

In some arrangements, the method 400a further includes receiving, by the relay UE from the source UE (directly or via a relay UE), a data packet with a destination identified by the destination ID (in the adapt header) of the destination UE, determining, by the relay UE, the original destination ID corresponding to the destination ID using the mapping, and sending, by the relay UE to the destination UE (directly or via a relay UE), the data packet with the destination identified by the original destination ID in the adapt header.

In response to the relay UE 702a receiving a data packet from the relay UE 702b with the original destination ID (identifying the source of the data packet is the destination UE 703a) in the adapt header, the relay UE 702a looks up the new destination ID using the original destination ID in the mapping table and replaces the original destination ID with the new destination ID in the adapt header and sends the data packet to the source UE 701. The source UE 701 can identify based on the new destination ID that the data packets is from the destination UE 703a (based on the new destination ID).

In some arrangements, the method 400a further includes receiving, by the relay UE from the destination UE (directly or via a relay UE), a data packet with a source identified by the original destination ID (in the adapt header), determining, by the relay UE, the destination ID corresponding to the original destination ID using the mapping, and sending, by the relay UE to the source UE (directly or via a relay UE), the data packet with the source identified by the destination ID in the adapt header.

In some arrangements, the relay UE 702a notifies the new destination ID to the relay UE 702b and/or the destination UE 703a (e.g., via at least one PC5-S message or at least one PC5-RRC message). In some arrangements, the method 400a further includes sending, by the relay UE (e.g., the relay UE 702a) to the destination UE (e.g., the destination UE 703a), either directly by sending at least one PC5-S message or at least one PC5-RRC message to the destination UE or via at least one relay UE (e.g., the relay UE 702b), the new destination ID of the destination UE in response to assigning the destination ID. In some arrangements, the method 400a further includes sending, by the relay UE (e.g., the relay UE 702a) to the source UE (e.g., the source UE 701), either directly by sending at least one PC5-S message or at least one PC5-RRC message to the destination UE or via at least one relay UE, the new destination ID of the destination UE in response to assigning the destination ID. In some arrangements, the method 400a further includes sending, by the relay UE (e.g., the relay UE 702a) to another relay UE (e.g., the relay UE 702b), either directly by sending at least one PC5-S message or at least one PC5-RRC message to that relay UE or via at least one other relay UE, the new destination ID of the destination UE in response to assigning the destination ID.

In some examples, to avoid such L2 ID collision, the relay UE 702a notifies the ID collision to the destination UE 703a (e.g., via the relay UE 702b via at least one PC5-S message or at least one PC5-RRC message). The destination UE 703a assigns a new destination ID and informs the new destination ID to at least one of the relay UE 702b, the relay UE 702a (via the relay UE 702b), or the source UE 701 (via the relay UEs 702a and 702b) via at least one PC5-S message or at least one PC5-RRC message).

In some arrangements, the method 400a further includes in response to determining that an original destination ID of the destination UE is currently used by another destination UE for another E2E unicast link, the relay UE sends to the destination UE (directly or via a relay UE), a message notifying the destination UE that the original destination ID of the destination UE is currently used by another destination UE. The relay UE receives from the destination UE the destination ID (e.g., the new destination ID) of the destination UE. As described, the source ID is the source UE's L2 ID, and the destination ID is the destination UE's L2 ID.

FIG. 8 is a diagram illustrating an example method 800 for communicating UE IDs for a E2E link between a first UE 801 and a second UE 803, according to various arrangements. Each of the first UE 801 and the second UE 803 can be a source UE or a destination UE as described.

In some arrangements, a first UE 801 assigns IDx1 to itself and sends the IDx1 to the first relay UE 802a. The first relay UE 802a checks whether ID×1 is already used by/for another remote UE in another path through the first relay UE 802a. If not, the first relay UE 802a sends the ID×1 of the first UE 801 to a second relay UE 802b. The second relay UE 802b checks whether ID×1 is already used by/for another remote UE in another path through the second relay UE 802b. If yes, the second relay UE 802b assigns the new ID×2 to the first UE 801 and informs to the first relay UE 802a and its next hop node (e.g., a third relay UE), and so on. The last nth relay UE 802n assigns the new ID×n to the first UE 801 and informs to the (n-1)th relay UE and the second UE 803. IDx2 to IDxn assigned by relay UEs 802a-802n to the first UE 801 are the same format with IDx1, e.g. 24 bits L2 ID.

When the first UE 801 sends data to the second UE 803 via the at least one relay UE 802a-802n, the first UE 801 uses the IDx1 as the source ID in the adapt header and sends to the first relay UE 802a. When the first relay UE 802a forwards the data packet of the first UE 801 to the next hop node (the second relay UE 802b), the first relay UE 802a replaces the source ID to ID×2 which was assigned by the next hop node (the second relay UE 802b) for the first UE 801. Alternatively, the first relay UE 802a may not replace the source ID (maintains ID×1 in the adapt header), and the second relay UE 802b can identify the packet from the first relay UE 802a with ID×1 is for the first UE 801 based on the stored ID mapping information. When the second relay UE 802b forwards the data packet of the first UE 801 to the next hop node (e.g., the third relay UE), the second relay UE 802b replaces the source ID to the ID which was assigned by the next hop node or to the ID×2 assigned by itself. When relay nth relay UE 702n assigns forwards the data packet of remote the first UE 801 to the second UE 803, the nth relay UE 702n assigns replaces the source ID to ID×n it assigned to the first UE 801.

When the second UE 803 sends data to the first UE 801 via the at least one relay UE, the second UE 803 shall use the ID×n which assigned by the next hop (relay UE N) as the destination UE ID in the adapt header and send the data packet to relay UE N. When the second relay UE 802b forwards the data packet (from the second UE 803 to the first UE 801) to the first relay UE 802a, the second relay UE 802b replaces the destination UE ID field to ID×1 which comes from the next hop (the first relay UE 802a). Then the first relay UE 802a forwards the data packet to the first UE 801 without replacing the destination UE ID field in the adapt header. Alternatively, the second relay UE 802b forwards the data packet to the first relay UE 802a using the IDx2 as destination UE ID in the adapt header. When the first relay UE 802a receives the packet it identifies the packet is destined to the first UE 801 and replaces the destination UE ID field to IDx1 when forwarding to the first UE 801.

In some arrangements, the ID mappable to a source UE or a destination UE used in adapt header can be a local ID. The local ID can be exchanged before E2E PC5 unicast link establishment.

In some arrangements, the local ID for source UE or destination UE could be assigned by relay UE via PC5-S or PC5-RRC messages. The local ID is unique within the scope of the relay UE, it may be 8 bits or other bits. As discussed above, if PC5-RRC message is used to, when the relay UE informs the assigned local ID of the destination UE to the source UE, the user information ID or L2 ID of destination UE is also included to identify the destination UE. If PC5-RRC message is used to, when the relay UE informs the assigned local ID of the source UE to the destination UE, the user information ID or L2 ID of destination UE is also included to identify the destination UE.

In multi-hop scenario for example as shown in FIG. 8, the relay UE 802a assigns a local ID IDx1 to the first UE 801 and IDy1 to the second UE 803 and informs the assigned local IDs to the first UE 801 and the relay UE 802b. Then relay UE 802b can re-assign local IDx2 and IDy2 to the UE pair (e.g., IDx2 to first UE 801 and IDy2 to the second UE 803) and informs the assigned local IDs to the relay UE 802a and an immediate downstream UE not shown, etc. The last nth relay UE 802n can re-assign local IDxn and IDyn to the UE pair (e.g., IDxn to first UE 801 and IDyn to the second UE 803) and informs the assigned IDs to the (n-1)th relay UE and the second UE 803.

In some arrangements, the method 400a further includes determining, by the relay UE, a first local source ID for the source UE sending, by the relay UE using at least one first PC5-S message or at least one first RRC message, the first local source ID to at least one of an upstream UE or a downstream UE, determining, by the relay UE, a first local destination ID for the destination UE, and sending, by the relay UE using at least one second PC5-S message or at least one second RRC message, the first local destination ID to at least one of the upstream UE or the downstream UE. The upstream UE includes the source UE or an upstream relay UE. The downstream UE includes the destination UE or a downstream relay UE.

In some examples, the first RRC message further includes a user information ID or an L2 ID of the source UE and the ID used to identify the source wireless UE. The user information ID indicates the source UE to which the source ID belongs. In some examples, the second RRC message further includes a user information ID or a L2 ID of the destination UE and the ID used to identify the destination UE. The user information ID indicates the destination UE to which the destination ID belongs. In the example in which both a first source UE and a second source UE are establishing the E2E link with the destination UE, the different user information IDs of the first and second source UEs can be used by the destination UE to identify the source IDs as belonging respective user information IDs.

The first UE 801 transmits a data packet to the second UE 803, the first UE 801 includes the local IDs (e.g., IDx1, IDy1) assigned by the next hop (e.g., the relay UE 802a) as the source ID and destination ID in adapt header for the data packet. In response to receiving the data packet, the relay UE 802a replaces the adapt header with the local IDs (IDx2, IDy2) assigned by the relay UE 802b and forwards the data packet with the replaced local IDs to the next hop node, etc. The (n-1)th relay UE replaces the adapt header with local IDs (IDxn, IDyn) assigned by the next hop node (e.g., the nth relay UE 802n) and forwards the data packet to nth relay UE 802n. The nth relay UE 802n recognizes that itself is the last relay UE and forwards the packets (without changing the adapt header) to the second UE 803. In some arrangements, the source ID is not included in the adapt header of the first hop (between the first UE 801 to the relay UE 802a). In some arrangements, the destination ID is not included in the adapt header of the last hop (between the relay UE 802n and the second UE 803).

In some arrangements, the method 400a further includes receiving, by the relay UE from the upstream relay UE, a data packet with a destination identified by the first local destination ID of the destination UE (in the adapt header), determining, by the relay UE, a second local destination ID corresponding to the first local destination ID (the second local destination ID is assigned by the downstream relay UE), and sending, by the relay UE to the downstream relay UE, the data packet with the destination identified by the second local destination ID (in the adapt header). In some arrangements, the method 400a further includes receiving, by the relay UE from the upstream relay UE, a data packet with a source identified by the first local source ID of the source UE (in the adapt header), determining, by the relay UE, a second local source ID corresponding to the first local source ID (the second local source ID is determined by the downstream relay UE), and sending, by the relay UE to the downstream relay UE, the data packet with the source identified by the second local source ID (in the adapt header).

The second UE 803 transmits a data packet to the first UE 801, the second UE 803 includes the local IDs (e.g., IDyn, IDxn) assigned by the next hop (e.g., the relay UE 802n) as the source ID and destination ID in adapt header for the data packet. In response to receiving the data packet, the relay UE 802n replaces the adapt header with the local IDs (IDyn-1, IDxn-1) assigned by the relay UE 802n-1 and forwards the data packet with the replaced local IDs to the next hop node, etc. The relay UE 802b replaces the adapt header with local IDs (IDy1, IDx1) assigned by the next hop node (e.g., the relay UE 802a) and forwards the data packet to relay UE 802a. The relay UE 802a recognizes that itself is the last relay UE and forwards the packets (without changing the adapt header) to the first UE 801. In some arrangements, the destination ID is not included in the adapt header of the first hop (between the second UE 803 to the relay UE 802n). In some arrangements, the source ID is not included in the adapt header of the last hop (between the relay UE 802a and the first UE 801).

In some arrangements, the method 400a further includes receiving, by the relay UE from the downstream relay UE, a data packet with a source identified by a first local destination ID of the destination UE in the adapt header. The first local destination ID is assigned by the relay UE. The downstream relay UE determines the first local destination ID corresponding to a second local destination ID. The second local destination ID is assigned by the downstream relay UE. The method 400a further includes sending, by the relay UE to the upstream relay UE, the data packet with the source identified by the first local destination ID in the adapt header. In some arrangements, the method 400a further includes receiving, by the relay UE from the downstream relay UE, a data packet with a destination identified by a first local source ID of the source UE in the adapt header. The first local source ID is assigned by the relay UE. The downstream relay UE determines the first local source ID corresponding to a second local source ID. The second local source ID is assigned by the downstream relay UE. The method 400a further includes sending, by the relay UE to the upstream relay UE, the data packet with the destination identified by the first local source ID in the adapt header.

In some arrangements, the local ID of each remote UE is allocated by UE itself. The local ID of source UE is allocated by source UE itself. The local ID of destination UE is allocated by destination UE itself. The ID assignment, ID avoidance and adapt header replacing when data forwarding are actually the same as L2 ID as described herein.

In some arrangements, the local ID of source UE is allocated by the source UE per destination UE, e.g., for destination UE, the source UE allocates ID1 for itself, for destination UE, the source UE allocates ID2 for itself. Source UE informs the allocated ID to the destination UE and intermediate relay UEs. In other words, each UE allocates local ID for itself for a particular U2U relay communication (a E2E PC5 link/a source-destination pair). In some arrangements, in the method 400a, the source UE allocates a first source ID. The relay UE allocates a second source ID in response to determining that the first source ID is used by a UE of a first existing communication path. The destination UE allocates a first destination ID. The UE allocates a second destination ID in response to determining that the first destination ID is used by a UE of a second existing communication path. In some arrangements, the first source ID includes an L2 ID or a local ID of the source UE. The second source ID includes an L2 ID or a local ID of the source UE. The first destination ID includes an L2 ID or a local ID of the destination UE. The second destination ID includes an L2 ID or a local ID of the destination UE.

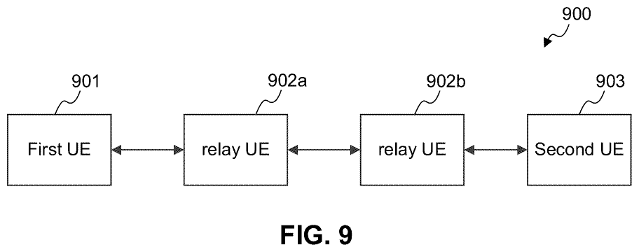

FIG. 9 is a diagram illustrating an example method 900 for communicating UE IDs for a E2E link between a first UE 901 and a second UE 903, according to various arrangements. Each of the first UE 901 and the second UE 903 can be a source UE or a destination UE as described.

In some arrangements, a first UE 901 assigns IDx to itself and sends the IDx to the first relay UE 902a (e.g., using a PC5-S message or an RRC message). The first relay UE 902a checks whether IDx is already used by/for another remote UE in another path through the first relay UE 902a. If not, the first relay UE 902a sends IDx to the second relay UE 902b (e.g., using a PC5-S message or an RRC message). If yes, the first relay UE 902a assigns the new IDx1 to the first UE 801 and informs to the second relay UE 902b (e.g., using a PC5-S message or an RRC message). The second relay UE 902b checks whether IDx or IDx1 is already used by/for another remote UE in another path through the second relay UE 902b. If not, the second relay UE 902b sends IDx or IDx1 to the second UE 903 (e.g., using a PC5-S message or an RRC message). If yes, the second relay UE 902b assigns the new IDx2 to the first UE 801 and informs to the second UE 903 (e.g., using a PC5-S message or an RRC message).

In some arrangements, the second UE 903 assigns IDy to itself and sends the IDy to the second relay UE 902b (e.g., using a PC5-S message or an RRC message). The second relay UE 902b checks whether IDy is already used by/for another remote UE in another path through the second relay UE 902b. If not, the second relay UE 902b sends IDy to the first relay UE 902a(e.g., using a PC5-S message or an RRC message). If yes, the second relay UE 902b assigns the new IDy1 to the second UE 803 and informs to the first relay UE 902a (e.g., using a PC5-S message or an RRC message). The first relay UE 902a checks whether IDy or IDy1 is already used by/for another remote UE in another path through the first relay UE 902a. If not, the first relay UE 902asends IDy or IDy1 to the first UE 901. If yes, the first relay UE 902a assigns the new IDy2 to the second UE 803 and informs to the first UE 901.

In the example in which the first UE 901 assigns IDx to itself, the first relay UE 902aassigns IDx1 to the first UE 901, the second relay UE 902b assigns IDx2 to the first UE 901, and IDy can be used by the UEs 901, 902a, 902b, and 903, the first UE 901 transmits a data packet to the second UE 903, the first UE 901 includes the IDs (e.g., IDx, IDy) as the source ID and destination ID in adapt header for the data packet. In response to receiving the data packet, the relay UE 902a replaces the adapt header with the IDs (IDx1, IDy) and forwards the data packet with the replaced local IDs to the next hop node, the relay UE 902b. The relay UE 902b replaces the adapt header with IDs (IDx2, IDy) and forwards the data packet to the second UE 803.

In some arrangements, the method 400a further includes receiving, by the relay UE from the upstream UE (e.g., a source UE or an upstream relay UE), a data packet with a destination identified by a first local destination ID of the destination UE (determined by the upstream UE) in the adapt header, determining, by the relay UE, a second local destination ID corresponding to the first local destination ID (the second local destination ID is determined by the relay UE), and sending, by the relay UE to the downstream UE (e.g., a destination UE or a downstream relay UE), the data packet with the destination identified by the second local destination ID in the adapt header. In some arrangements, the method 400a further includes receiving, by the relay UE from the upstream UE (e.g., a source UE or an upstream relay UE), a data packet with a source identified by a first local source ID of the source UE (determined by the upstream UE) in the adapt header, determining, by the relay UE, a second local source ID corresponding to the first local source ID (the second local source ID is determined by the relay UE), and sending, by the relay UE to the downstream UE (e.g., a destination UE or a downstream relay UE), the data packet with the destination identified by the second local source ID in the adapt header.

In the example in which the first UE 901 assigns IDx to itself, the first relay UE 902a assigns IDx1 to the first UE 901, the second relay UE 902b assigns IDx2 to the first UE 901, and IDy can be used by the UEs 901, 902a, 902b, and 903, the second UE 903 transmits a data packet to the first UE 901, the second UE 903 includes the IDs (e.g., IDy, IDx2) as the source ID and destination ID in adapt header for the data packet. In response to receiving the data packet, the relay UE 802b replaces the adapt header with the IDs (IDy, IDx1) and forwards the data packet with the replaced local IDs to the next hop node, the relay UE 902a. The relay UE 902a replaces the adapt header with local IDs (IDy, IDx) and forwards the data packet to the first UE 901.

In some arrangements, the method 400a further includes receiving, by the relay UE from the downstream UE (e.g., a destination UE or a downstream relay UE), a data packet with a destination identified by a first local source ID of the source UE (determined by the downstream UE) in the adapt header, determining, by the relay UE, a second local source ID corresponding to the first local source ID (the second local source ID is determined by the relay UE), and sending, by the relay UE to the upstream UE (e.g., a source UE or an upstream relay UE), the data packet with the destination identified by the second local source ID in the adapt header. In some arrangements, the method 400a further includes receiving, by the relay UE from the downstream UE (e.g., a destination UE or a downstream relay UE), a data packet with a source identified by a first local destination ID of the destination UE (determined by the downstream UE) in the adapt header, determining, by the relay UE, a second local destination ID corresponding to the first local destination ID (the second local source ID is determined by the relay UE), and sending, by the relay UE to the upstream UE (e.g., a source UE or an upstream relay UE), the data packet with the source identified by the second local destination ID in the adapt header.

In some arrangements, the ID mappable to a source UE or a destination UE used in adapt header can be a common ID or link ID. The common ID or the link ID is an ID representing the source and destination UE pair and can be exchanged before E2E PC5 unicast link establishment.

With reference to FIG. 8, in some arrangements, a first UE 801 assigns IDx1 to the UE pair including the UEs 801 and 803 and sends the IDx1 to the first relay UE 802a. The first relay UE 802a assigns the new IDx2 to the UE pair and sends IDx2 to the upstream relay UE (relay UE 802a) and the downstream relay UE (relay UE 802b), and so on. The last nth relay UE 802n assigns the new IDx n to the UE pair and informs to the (n-1)th relay UE and the second UE 803. Given that the common/link ID represents the source and destination UE pair/PC5 unicast link between the UEs 801 and 803, only one ID is included in the adapt header (different from the above cases that two IDs included in the adapt header). When data forwarding, each node may replace the UE ID in the adapt header to the ID assigned by the next hop node and forwards the data packet to the next hop node.

In some arrangements, the method 400a further includes determining, by the relay UE, a first common ID for a pair of the source UE and the destination UE, sending, by the relay UE, the first common ID to at least one of an upstream UE or a downstream UE. The upstream UE includes the source UE or an upstream relay UE, and the downstream UE includes the destination UE or a downstream relay UE.

In some arrangements, the method 400a further includes receiving, by the relay UE from the upstream UE, a data packet with a destination identified by the first common ID, determining, by the relay UE, a second common ID for the pair of the source UE and the destination UE corresponding to the first common ID (the second common ID is determined by the downstream UE), and sending, by the relay UE to the downstream UE, the data packet with the destination identified by the second common ID.

In some arrangements relating to emergency service for UE-to-Network (U2N) relays, emergency service is defined as citizen to authority services. National authorities decide whether the network accepts emergency calls. When a 5G ProSe-enabled UE does not have direct connection to the network for emergency service, the UE may attempt to obtain emergency service via 5G ProSe Layer-2 or Layer-3 U2N relay.

To support relaying emergency service for U2N relay, the BS can indicate the support of relaying emergency service so that the relay UE can forward emergency service for the remote UE. Specifically, the BS includes the indication of support of relaying emergency service for U2N relay in System Information Block 1 (SIB1). In some arrangements, a method includes sending, by the BS to a UE in SIB1, an indication indicating that relaying emergency service for U2N relay is supported. The UE receives such indication.

In response to receiving Protocol Data Unit (PDU) session establishment/modification request for emergency service for a remote UE from 5GC, the BS can select an appropriate relay UE (i.e. a relay UE supports emergency service relaying) for relaying of emergency service for the remote UE. In order for the BS to select a relay UE supporting emergency service relaying, various factors can be considered. That is, the BS can select a relay UE of a plurality of UEs based on at least one of the factors described herein.

In some examples, the BS sends an indication indicating the remote UE to report candidate relay UEs supporting emergency service relaying upon receiving PDU session establishment/modification request for emergency service for the remote UE from 5GC. In some examples, the BS sends an indication indicating the remote UE to update SL relay measurement report.

In some examples, new measurement report event is configured. Example Event E includes the PC5 link quality between the remote UE and a candidate relay UE supporting emergency service relaying is above a threshold. The BS sends the new measurement report event to remote UE.

In some examples, when the remote UE initiate to establish an emergency PDU session, remote UE sends an updated SL measurement report to BS including candidate relay UEs that supporting emergency service relaying and the PC5 link quality with the remote UE is above a threshold.

In some examples, the BS may send an indication to remote UE that indicates the remote UE to select a relay UE. Then the remote UE can select a relay UE supporting emergency service relaying by itself. The remote UE reports the selected relay UE to BS.

In some examples, for a BS to select an appropriate relay UE for emergency service relaying, relay UE may indicate to BS whether the relay UE supports relaying of emergency service for remote UE, via sidelinkUEInformation message or UE capability information or other RRC message. In some arrangements, the BS receives from a relay UE an indication indicating whether the relay UE supports relay of emergency services for another UE.

In some examples in which a relay UE is relaying an emergency service for a remote UE, the relay UE has its own emergency service, and the relay UE can prioritize its own emergency service establishment and stop relaying the remote UE's emergency service. To differentiate relay UE's own emergency service and relaying emergency service for remote UE, a new establishment/resume cause value indicating relaying emergency service for remote UE may be introduced. In some arrangements, the UE sends to BS, an establishment/resume cause value indicating relaying emergency service for another UE or emergency service for the UE.

In some arrangements, in legacy Hanover (HO) procedure, after receiving HO request acknowledge from a target BS, a source BS can send the Secondary Node (SN) status transfer to the target BS and forward UL/DL data to target BS. For DL data forwarding, the source BS may forward in order to the target BS all downlink Packet Data Convergence Protocol (PDCP) SDUs with their SN corresponding to PDCP PDUs which have not been acknowledged by the UE.

For inter-BS i2d/i2i path switch cases, due to the hop-by-hop Radio Link Control (RLC) in original indirect path, the source BS can forward to target BS all DL data which have not been acknowledged by the relay UE. That is, the source BS forwards DL data to target BS based on the receiving status of relay UE instead of remote UE. However, the receiving status of relay UE is not actually reflecting the receiving status of remote UE. Given that the path switching can be triggered due to worsening PC5 link quality, packet loss occurring at PC5 interface is likely due to the poor PC5 link quality. There may be some DL packets buffered at relay UE which have been RLC-ACKed by relay UE to source BS but have not been successfully transmitted to remote UE over PC5 hop. In this case, such packets are not forwarded by source BS to target BS if legacy Xn data forwarding is followed. Even the target BS gets PDCP status report from remote UE, the target BS cannot re-transmit such DL packets to remote UE as the target BS has not received the DL packets from source BS. Therefore, such DL packets will be missing at remote UE after remote UE successfully switched to the target BS.

In some arrangements, to ensure DL lossless delivery during inter-BS i2d/i2i path switch cases, enhanced data forwarding from source BS to target BS per target BS request (legacy PDCP status report based) can be provided. Specifically, the target BS relies on the legacy PDCP status report sent from the remote UE after path switch. The target BS requests the source BS to additionally forward the missing DL packets that were not forwarded earlier after receiving the PDCP status report.

In some arrangements, to ensure DL lossless delivery during inter-BS i2d/i2i path switch cases, a PDCP status report sent from remote UE to the source BS. Specifically, the source BS triggers the remote UE to send a PDCP status report to the source BS before the source BS performs SN status transfer to the target BS. The source BS can then forward the buffered data to the target BS based on the received PDCP status report, and the target BS can retransmit PDCP data PDUs to the remote UE as needed.

In some arrangements, to ensure DL lossless delivery during inter-BS i2d/i2i path switch cases, proactive data forwarding from source BS to target BS can be provided. The source BS forwards all the buffered data to the target BS without receiving the request from target BS.

In some arrangements, in response to receiving a HO request from source BS to request the path switch from indirect link to direct link or from indirect link to indirect link, in the HO request acknowledge message, the target BS indicates the source BS to perform legacy Xn data forwarding (e.g., forwarding all DL packets have not been acknowledged by the relay UE).

In some arrangements, in response to receiving a HO request from source BS to request the path switch from indirect link to direct link or from indirect link to indirect link, in the HO request acknowledge message, the target BS indicates the source BS to perform proactive Xn data forwarding (e.g., forwarding DL packets to target BS based on the PDCP status report (which have not been acknowledged) from remote UE, or forwarding all the buffered DL data to the target BS).

Then the source BS performs Xn data forwarding based on target BS's indication.

In some arrangements, source BS can perform legacy Xn data forwarding or proactive Xn data forwarding up to its implementation.

If legacy Xn data forwarding is performed, after receiving the PDCP status report from remote UE after path switch, target BS can request the source BS to additionally forward the missing DL packets (the packets that not been acknowledged by remote UE in PDCP status report and not been forwarded by source BS to target BS).

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed:

1. A wireless communication method, comprising:
providing, by a relay wireless communication device to a destination wireless communication device, a source ID of a source wireless communication device for an End-to-End (E2E) unicast link between the source wireless communication device and the destination wireless communication device; and
providing, by the relay wireless communication device to the source wireless communication device, a destination ID of the destination wireless communication device for the E2E unicast link.

2. The wireless communication method of claim 1, wherein the source ID is provided using a first PC5-S message received by the relay wireless communication device from the source wireless communication device and a second PC5-S message sent by the relay wireless communication device to the destination wireless communication device.

3. The wireless communication method of claim 1, wherein providing the source ID to the destination wireless communication device comprises:
receiving, by the relay wireless communication device from the source wireless communication device via a first link between the source wireless communication device and the relay wireless communication device, a first PC5-S message, the first PC5-S message comprises one of:
the source ID, wherein the source ID is different from an ID used to identify the source device for the first link; or
an indication indicating that the source ID for the E2E unicast link is same as the ID used to identify the source wireless communication device for the first link; and
sending, by the relay wireless communication device to the destination wireless communication device via a second link between the relay wireless communication device and the destination wireless communication device, a second PC5-S message comprising the source ID.

4. The wireless communication method of claim 1, wherein providing the destination ID to the source wireless communication device comprises:
receiving, by the relay wireless communication device from the destination wireless communication device via a second link between the destination wireless communication device and the relay wireless communication device, a third PC5-S message, the third PC5-S message comprises one of:
the destination ID, wherein the destination ID is different from an ID used to identify the destination device for the second link; or
an indication indicating that the destination ID for the E2E unicast link is same as the ID used to identify the destination wireless communication device for the second link; and
sending, by the relay wireless communication device to the source wireless communication device via a first link between the relay wireless communication device and the source wireless communication device, a fourth PC5-S message comprising the destination ID.

5. The wireless communication method of claim 1, wherein the source ID is provided using a first Radio Resource Control (RRC) reconfiguration message received by the relay wireless communication device from the source wireless communication device and a second RRC reconfiguration message sent by the relay wireless communication device to the destination wireless communication device.

6. The wireless communication method of claim 1, wherein providing the source ID to the destination wireless communication device comprises:
receiving, by the relay wireless communication device from the source wireless communication device via a first link between the source wireless communication device and the relay wireless communication device, a first Radio Resource Control (RRC) message, the first RRC message comprises one of:
the source ID, wherein the source ID is different from an ID used to identify the source wireless communication device for the first link; or
an indication indicating that the source ID for the E2E unicast link is same as the ID used to identify the source wireless communication device for the first link; and
sending, by the relay wireless communication device to the destination wireless communication device via a second link between the relay wireless communication device and the destination wireless communication device, a second RRC message comprising the source ID.

7. The wireless communication method of claim 1, wherein providing the destination ID to the source wireless communication device comprises:
receiving, by the relay wireless communication device from the destination wireless communication device via a second link between the destination wireless communication device and the relay wireless communication device, a third Radio Resource Control (RRC) message, the third RRC message comprises one of:
the destination ID, wherein the destination ID is different from an ID used to identify the destination wireless communication device for the second link; or
an indication indicating that the destination ID for the E2E unicast link is same as the ID used to identify the destination wireless communication device for the second link; and
sending, by the relay wireless communication device to the source wireless communication device via a first link between the relay wireless communication device and the source wireless communication device, a fourth RRC message including the destination ID.

8. The wireless communication method of claim 6, wherein the second RRC message further comprises a user information ID of the source wireless communication device and the ID used to identify the source wireless communication device, wherein the fourth RRC message further comprises a user information ID of the destination wireless communication device and the ID used to identify the destination wireless communication device.

9. The wireless communication method of claim 1, further comprising in response to determining that an original destination ID of the destination wireless communication device is currently used by another destination wireless communication device for another E2E unicast link:
assigning, by the relay wireless communication device, the destination ID for the destination wireless communication device;
storing, by the relay wireless communication device in a memory, a mapping of the original destination ID for the destination wireless communication device to the destination ID for the destination wireless communication device; and
sending, by the relay wireless communication device to the source wireless communication device, the destination ID.

10. The wireless communication method of claim 9, further comprising:
receiving, by the relay wireless communication device from the source wireless communication device, a data packet with a destination identified by the destination ID of the destination wireless communication device;
determining, by the relay wireless communication device, the original destination ID corresponding to the destination ID using the mapping; and
sending, by the relay wireless communication device to the destination wireless communication device, the data packet with the destination identified by the original destination ID.

11. The wireless communication method of claim 9, further comprising at least one of:
sending, by the relay wireless communication device to the destination wireless communication device, the destination ID of the destination wireless communication device in response to assigning the destination ID;
sending, by the relay wireless communication device to the source wireless communication device, the destination ID of the destination wireless communication device in response to assigning the destination ID; or
sending, by the relay wireless communication device to another relay wireless communication device, the destination ID of the destination wireless communication device in response to assigning the destination ID.

12. The wireless communication method of claim 9, further comprising:
receiving, by the relay wireless communication device from the destination wireless communication device, a data packet with a source identified by the original destination ID of the destination wireless communication device;
determining, by the relay wireless communication device, the destination ID corresponding to the original destination ID using the mapping; and
sending, by the relay wireless communication device to the source wireless communication device, the data packet with the source identified by the destination ID.

13. The wireless communication method of claim 1, further comprising:
in response to determining that an original destination ID of the destination wireless communication device is currently used by another wireless communication device for another E2E unicast link, sending, by the relay wireless communication device to the destination wireless communication device, a message notifying the destination wireless communication device that the original destination ID of the destination wireless communication device is currently used by another destination wireless communication device; and
receiving, by the relay wireless communication device from the destination wireless communication device, the destination ID of the destination wireless communication device.

14. The wireless communication method of claim 1, wherein
the source ID comprises an L2 ID or a local ID of the source wireless communication device; and
the destination ID comprises an L2 ID or a local ID of the destination wireless communication device.

15. The wireless communication method of claim 1, further comprising:
determining, by the relay wireless communication device, a first local source ID for the source wireless communication device;
sending, by the relay wireless communication device using at least one first PC5-S message or at least one first Radio Resource Control (RRC) message, the first local source ID to at least one of an upstream wireless communication device or a downstream wireless communication device, wherein the upstream wireless communication device comprises the source wireless communication device or an upstream relay wireless communication device, and the downstream wireless communication device comprises the destination wireless communication device or a downstream relay wireless communication device;
determining, by the relay wireless communication device, a first local destination ID for the destination wireless communication device;
sending, by the relay wireless communication device using at least one second PC5-S message or at least one second RRC message, the first local destination ID to at least one of the upstream wireless communication device or the downstream wireless communication device.

16. The wireless communication method of claim 15, wherein
the first RRC message further comprises a user information ID or a L2 ID of the source wireless communication device and the ID used to identify the source wireless communication device; and
the second RRC message further comprises a user information ID or a L2 ID of the destination wireless communication device and the ID used to identify the destination wireless communication device.

17. The wireless communication method of claim 15, further comprising
receiving, by the relay wireless communication device from the upstream relay wireless communication device, a data packet with a destination identified by the first local destination ID of the destination wireless communication device;
determining, by the relay wireless communication device, a second local destination ID corresponding to the first local destination ID, wherein the second local destination ID is assigned by the downstream relay wireless communication device; and
sending, by the relay wireless communication device to the downstream relay wireless communication device, the data packet with the destination identified by the second local destination ID.

18. A relay wireless communication device, comprising:
at least one processor configured to:
provide, via a transmitter to a destination wireless communication device, a source ID of a source wireless communication device for an End-to-End (E2E) unicast link between the source wireless communication device and the destination wireless communication device; and
provide, via the transmitter to the source wireless communication device, a destination ID of the destination wireless communication device for the E2E unicast link.

19. A wireless communication method, comprising:
determining, by a source wireless communication device, a source ID of the source wireless communication device for an End-2-End (E2E) unicast link between the source wireless communication device and a destination wireless communication device;
sending, by the source wireless communication device to a relay wireless communication device via a PC5-S message or an Radio Resource Control (RRC) message, the source ID; and
receiving, by the source wireless communication device from the relay wireless communication device, a destination ID of the destination wireless communication device for the E2E unicast link.

20. A source wireless communication device, comprising:
at least one processor configured to:
determine a source ID of the source wireless communication device for an End-2-End (E2E) unicast link between the source wireless communication device and a destination wireless communication device;
send, via a transceiver to a relay wireless communication device via a PC5-S message or an Radio Resource Control (RRC) message, the source ID; and
receive, via the transceiver from the relay wireless communication device, a destination ID of the destination wireless communication device for the E2E unicast link.
